(19) United States
(12) Patent Application Publication
(10) Pub. No.: US 2012/0246879 A1
(43) Pub. Date: Oct. 4, 2012

(54) Retainer Apparatus

(76) Inventors: Mark Pestal, Littleton, CO (US); Tyler Bagley, Louisville, CO (US)

(21) Appl. No.: 13/075,140

(22) Filed: Mar. 29, 2011

(51) Int. Cl. B65D 63/00; F16B 2/20

(52) U.S. Cl. 24/3.2; 24/302

(57) ABSTRACT

A retainer apparatus for removably engaging a tablet computer to a user's leg, the retainer apparatus includes a pair of opposed clips each being removably engagable to an outer periphery of the tablet, via a detachable extension member that is disposed to span between the opposing pair of clips resulting in the clips being compressed as against the tablet outer periphery at an angle that creates a moment that in effect rotates each clip to rotatably bind the clip to the tablet outer periphery for improved frictional contact between the clip and the tablet outer periphery. Also included in the retainer apparatus is a disconnectable band element that is removably attached to the extension member and is adapted to extend around and removably engage the user's leg.

### TECHNICAL FIELD

The present invention generally relates to an apparatus for retaining an article and specifically for retaining a computer adjacent to a human. More particularly, the present invention relates to the field of lightweight portable apparatus that are capable of removably engaging a portable computer in addition to the apparatus also being removably engagable to the human, wherein the retainer apparatus is typically worn by the human during piloting and other vehicle related activities.

### BACKGROUND OF INVENTION

With the accelerating plethora of technological advances in portable computing apparatus, there has been an explosion in applications for portable computers, namely in the form of pocket “smart phones”, laptops, and more recently in “pad” or “tablet” computers, which give an individual “on-the-go” computing capabilities and the attendant internet access. However, as opposed to the traditional desktop computer which of course is supported by the desk while being used, a portable computer has no desk, so this brings up an awkward situation, i.e. in the case of the smart phone the logistics form factor is to hold it in the palm of one's hand and typically initiate commands with the other hand or hold the smart phone with both palms and use both of one's thumbs, or even hold it in the palm of one hand and use that same hands thumb for commands. Of course in the case of the traditional laptop, it is placed on the tops of the user's legs as seated and the user uses both hands to type commands as with the desktop computer. Moving to the tablets or pad type portable computers, there is a logistical confusion of how exactly to hold it, as it is too large to be held much the same as a smart phone, however, the tablet can be used with one hand holding it and one hand giving commands, or placed flat on a table top—with the screen somewhat inconveniently flat on the table top—and placing the tablet on the user's lap as in the case of a traditional laptop—also puts the screen somewhat inconveniently flat. So this leaves some issues with the tablet on how exactly to hold it while using it?

As the tablet computer becomes more popular-do to its attractive features of being much smaller and lighter than a traditional laptop, more resistant to getting physically knocked around (due to solid state memory, etc.), much longer battery life, instant on feature, touch screen flexibility, and other features, there still remains the logistical form factor of just how exactly to hold it and give it user commands. Specifically in the case of piloting an aircraft or operating a vehicle, the tablet needs to be removably engaged to something, as the user cannot afford to hold the tablet, give it commands, and pilot or operate a vehicle simultaneously, so an apparatus for removably engaging the tablet to something is needed, wherein when the tablet is removably engaged to something, this something needs also to be of a somewhat consistent physical structural form factor, which eliminates for the most part removably engaging the tablet to a part of the plane or vehicle, which leaves us with the user themselves as being what the tablet removably engages to—plus removably engaging to the user—further facilitates the portability of the tablet computer—as opposed to needing a multitude of retainer apparatus customized for the unique physical structural attributes of all of the different planes and vehicles.

In looking at the prior art, structures that hold, retain, or removably engage actual old world paper tablets are included, as their physical structural form factor is close to the tablet computer retainer apparatus. Starting with U.S. Pat. No. 6,520,394 to Ulibarri, disclosed is a pad holder for allowing a user to write comfortably and legibly on their leg for the application of being a pilot, see FIG. 1. The pad in Ulibarri includes a plurality of sheets adapted to be written upon, each sheet having a plurality of spaced diagonal writing guide lines extending across a width thereof, being specifically for the pilots convenience. A base section in Ulibarri is provided with a clip connected thereto for selectively retaining the sheets on the base. A latching mechanism in Ulibarri releasably secures the base section to a leg of a user allowing notes to be written between the lines on a top sheet while seated with an arm in a comfortable writing position. The plurality of lines in Ulibarri on each sheet extend upward from a left side to a right side to accommodate a right hand person or extend downward from a left side of to a right side to accommodate a left-handed person. The lines in Ulibarri are preferably inclined at an angle of between substantially twenty-five to substantially thirty-five degrees with a heading being printed near a top edge of each sheet, the heading being a visual flight rules/instrument flight rules form. The base section in Ulibarri further includes a base and a knee board connected to the base in an angularly adjustable manner, the clip selectively securing the sheets to the knee board. With the novelty in Ulibarri residing in the angled sheet lines and the V shaped member for retaining the knee board at an angle to the base.

Continuing in the prior art, in U.S. Pat. No. 7,810,683 to Chan, disclosed is a carrier that includes a base and a clear plastic top member connected to the base via a plurality of spaced binding bands with a receiving space formed between them for holding or sandwiching a handheld video device therein, somewhat in the form of a face clamp, and an arm band extended across and releasably secured to a lower side of the base for binding the carrier around a user's arm. The binding bands in Chan are length adjustably connected at a proximal end to peripheral edges of the top member, and are provided on a back side with a hook fastener surface, each for releasably securing to loop fastener surfaces provided on the lower side of the base. The novelty in Chan is in the binded sandwiching structure with the clear plastic cover, allowing some degree of variance in the sizes of video devices accommodated, thus making the Chan retainer more universal in its applicability in absolutely not having to utilize or rely upon the outer periphery of the video device to retain it, thus as long as the video device fits within the outer clamping bands located on the periphery of the sandwich clamps.

Next, in U.S. Pat. No. 5,937,765 to Stirling, disclosed is a leg-worn support assembly for a laptop computer. In Stirling, there is a substantially planar, rigid platform for attachment to the computer, and first and second tensioned leg straps which depend from the edges of the platform for extending around the user's leg. A pad in Stirling is mounted on the lower surface of the platform and has an inverted channel area therein for engaging the upper edge of the leg for lateral stability. Non-slip surfaces in Stirling are formed on both the leg straps and the inverted channel area for frictionally engaging the leg so as to provide a laterally stable work platform. The novelty in Stirling is in the inverted channel that is adjacent to the user's leg, wherein the channel compresses about the user's leg from the tension of the retention straps.

Further, in U.S. Pat. No. 4,919,037 to Mitchell, disclosed is a high quality ballistic protection which can be thrust into the muzzle of a gun at close range to shield the potential victim by stopping direct shots and by causing the assailant to fire at an angle which will cause the bullet to miss the victim because of the close proximity of the shield to the gun. A further objective in Mitchell of the invention is to provide a shield with the further utility of a writing board with handle means for handling and holding some fashion of clipboard means for fixing the writing materials in place while writing. The novelty in Mitchell is in the pocket and wrist strap combination for support of the planar shaped ballistic protection.

Next, looking to U.S. Pat. No. 7,469,809 to Rodarte, et al., disclosed is a carrier for a portable device having a shoulder strap with a padded region and a cord region. The padded region is adapted to rest on a superior portion of a person's shoulder. A shoulder strap catch in Rodarte, et al., is adapted to be coupled at an end thereof to a portable device; and the shoulder strap catch defines an opening through which the cord region of the shoulder strap is slidably retained. The portable device in Rodarte, et al. may be moved from a carry to a use position, along the shoulder strap, without dislodging the padded region. In addition or alternatively in Rodarte, et al., the carrying apparatus is a hand strap coupled at a first end to side of a portable device at substantially a center portion thereof. The second end of the hand strap in Rodarte, et al. is removably coupled to a strap attachment bracket positioned proximate the opposite side of the portable device, and having a bracket attachment area that can be reversed to support a right or left-handed orientation. The novelty in Rodarte, et al. is in the strap attachment at the second end (see elements 34 and 40) that allows the strap to be selectively positioned in a left or right hand mode.

What is needed is a simple retainer apparatus for a tablet computer to attach/detach the tablet to and from the user's leg in a easy and quick manner. However, while being attached the retainer apparatus securing holding the tablet computer in place with a unique clip configuration to minimize the number of clips needed while enhancing the frictional grip that each clip has upon the tablet outer periphery.

### SUMMARY OF INVENTION

Broadly, the present invention is for a retainer apparatus for removably engaging a tablet computer having a planar display and an outer periphery, the tablet computer display forming a plane, wherein the retainer apparatus is adapted to be removably engaged to a user's leg. The retainer apparatus includes a pair of opposed clips each having an extension portion and a channel portion, each channel portion being removably engagable to the tablet outer periphery, each clip extension portion includes an extension axis, the clip further has an offset primary channel that is disposed within the channel portion. The offset primary channel including a primary channel long axis that is perpendicular to the extension axis and a primary channel short axis that is parallel to the extension axis, wherein the extension axis and the primary channel short axis form an acute angle to one another resulting in the extension axis angling away from the display plane when each clip is engaged to the tablet outer periphery.

Further included in the retainer apparatus is a detachable extension member having a longitudinal axis that is disposed to span between the opposing pair of clips when the extension member is attached to each extension portion resulting in the clips being compressed as against the tablet outer periphery. This compression also creating a moment that is about the primary channel long axis from the acute angle causing a force from the extension axis to the short axis in effect rotating the clip to both compress and rotatably bind the primary channel portion as against the tablet outer periphery for the purpose of initiating frictional contact on all channel sides for an improved frictional contact as between the clip and the tablet outer periphery. Also included in the retainer apparatus is a disconnectable band element having a longwise axis, wherein the band element is removably attached to the extension member and further the band element is adapted to extend around and removably engage the user's leg, wherein operationally the retainer apparatus removably retains the tablet computer to the user's leg.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows a perspective view of the planar article having the plane and the outer periphery are also shown, or more specifically the tablet computer, the planar display, the plane formed by the display, and the outer periphery of the tablet computer;

FIG. 2 shows a perspective view of the planar article having the plane and the outer periphery are also shown, or more specifically the tablet computer, the planar display, the plane formed by the display, and the outer periphery of the tablet computer, wherein the tablet computer also has the close fitting protective cover that is opened to expose the display, the close fitting cover also creates the double outer periphery on either the planar article or the tablet computer;

FIG. 3 shows a perspective view of the planar article having the plane and the outer periphery is also shown, or more specifically the tablet computer, the planar display, the plane formed by the display, and the outer periphery of the tablet computer, wherein the tablet computer also has the close fitting protective cover that is closed to protect the display, the close fitting cover also creates the double outer periphery on either the planar article or the tablet computer;

FIG. 4 shows a perspective view of the clip including the extension portion, the extension portion length, the extension axis, the channel portion, the offset primary channel, the width and length of the primary channel, the surface area of the primary channel, the unit surface pressure loading of the primary channel, the long axis of the primary channel, the short axis of the primary channel, the perpendicular relationship of the primary channel long axis to the extension axis, the substantially parallel relationship of the extension axis to the primary channel short axis, the acute angle between the extension axis and the primary channel short axis, the secondary channel, the width of the secondary channel, length of the secondary channel, surface area of the secondary channel, unit surface pressure loading of the secondary channel, and frictional contact of the secondary channel;

FIG. 5 shows a side elevation view of the clip including the extension portion, the extension portion length, the extension axis, the channel portion, the offset primary channel, the width of the primary channel, the surface area of the primary channel, the unit surface pressure loading of the primary channel, the short axis of the primary channel, the substantially parallel relationship of the extension axis to the primary channel short axis, the acute angle between the extension axis and the primary channel short axis, the secondary channel, width of the secondary channel, surface area of the secondary channel, unit surface pressure loading of the secondary channel, and frictional contact of the secondary channel;

FIG. 6 shows a plan elevation view of the clip including the extension portion, the extension portion axis, the length of the extension portion, the length of the primary channel, and the length of the secondary channel;

FIG. 7 is cross section 7-7 from FIG. 10, and shows the interface of the clip and extension member, with the double outer periphery of both the planar article and the tablet computer, being in particular with the close fitting protective cover that is of a resilient nature further facilitating the moment that creates the rotatable binding of the primary channel and the secondary channel as against the double outer periphery as shown from both the angle that is between the extension axis and the primary channel short axis and the compression on the clip from the extension member and the force from the extension axis to the primary channel short axis, this results in the unit surface pressure loading of the primary channel and the unit surface pressure loading of the secondary channel as against the resilient cover at the double outer periphery to increase the frictional contact of the secondary channel thus enabling the clip to better grip the planar article or tablet computer outer periphery;

FIG. 8 shows a perspective view of the pair of clips, with the channel portion, the secondary channel, with the extension member, the longitudinal axis of the extension member, the compression of the clips, and the force on the clips that result in the moment on the clips;

FIG. 9 is the inverted view of the pair of clips and extension member of FIG. 8, showing the channel portion, the secondary channel, the longitudinal axis of the extension member, the compression of the clips, the force on the clips that result in the moment on the clips, the band element, and the longwise axis of the band element; and

FIG. 10 shows a use perspective view of the retainer apparatus that is adapted to attach to the user's leg or a body portion, with the planar article or tablet computer shown retained to the user via the clips having the moment causing the rotatable binding of the clip upon the outer periphery or double outer periphery of the planar article or tablet computer, thus allowing use of the tablet computer without having to manually hold it.

### REFERENCE NUMBERS IN DRAWINGS

50 Retainer apparatus
55 Planar article
60 Plane formed from planar article 55
65 Outer periphery of planar article 55
70 Double outer periphery of planar article 55
75 Tablet computer
76 Cover, close fitting and protective for the tablet computer 75
80 Planar display of tablet computer 75
85 Plane formed from display 80
90 Outer periphery of tablet computer 75
95 Double outer periphery of tablet computer 75
100 Body portion
105 User's leg
110 Clip
115 Extension portion of the clip 110
120 Length of extension portion 115
125 Extension axis of the extension portion 115
130 Channel portion of the clip 110
135 Offset primary channel
140 Width of primary channel 135
145 Length of primary channel 135
150 Surface area of primary channel 135
155 Unit surface pressure loading of primary channel 135
160 Long axis of primary channel 135
165 Short axis of primary channel 135
170 Perpendicular relationship of the primary channel 135 long axis 160 to the extension axis 125
175 Substantially parallel relationship of the extension axis 125 and the primary channel 135 short axis 165
180 Acute angle between the extension axis 125 and the primary channel 135 short axis 165
185 Secondary channel
190 Width of secondary channel 185
195 Length of secondary channel 185
200 Surface area of secondary channel 185
205 Unit surface pressure loading of secondary channel 185
210 Frictional contact of secondary channel 185
215 Extension member
220 Longitudinal axis of the extension member 215
225 Compression of the clips 110
230 Moment of the clips 110
235 Force from extension axis 125 to the primary channel 135 short axis 165
240 Rotatable binding of the primary channel 135 against the article outer periphery 65 or tablet computer 75 outer periphery 90
245 Initiating frictional contact on all primary channel 135 sides
250 Rotatable binding of the primary channel 135 and the secondary channel 185 against the article outer double periphery 70 of tablet computer 75 double outer periphery 95
255 Initiating frictional contact on all secondary channel 185 sides
260 Band element
265 Longwise axis of the band element 260
270 Adaption of the band element 260 to the body portion 100 or user's leg 105

### DETAILED DESCRIPTION

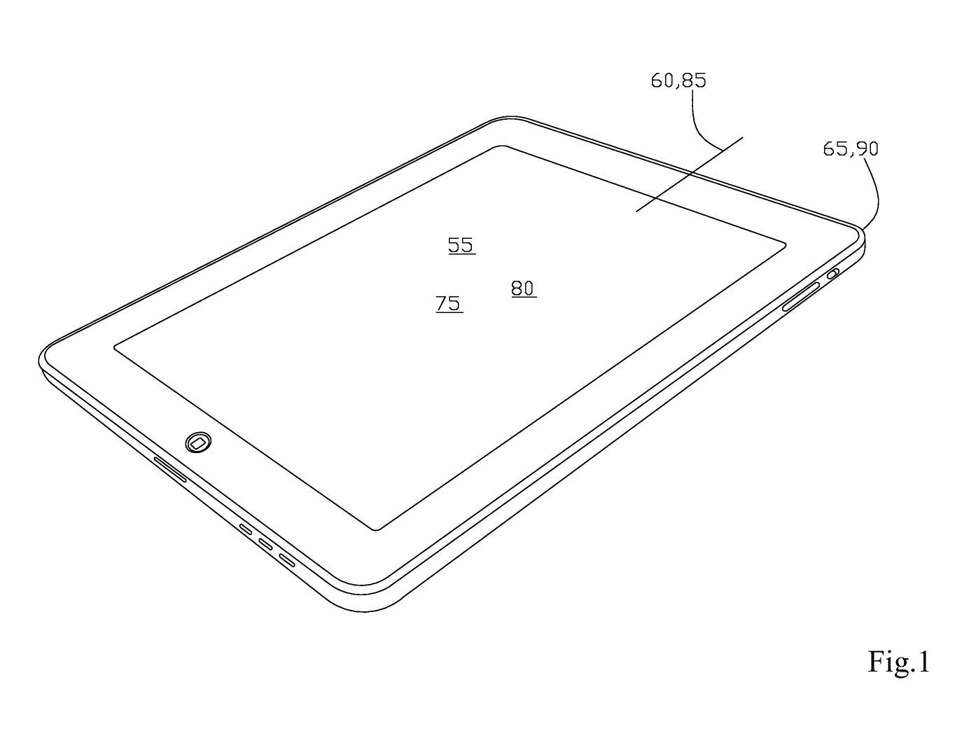

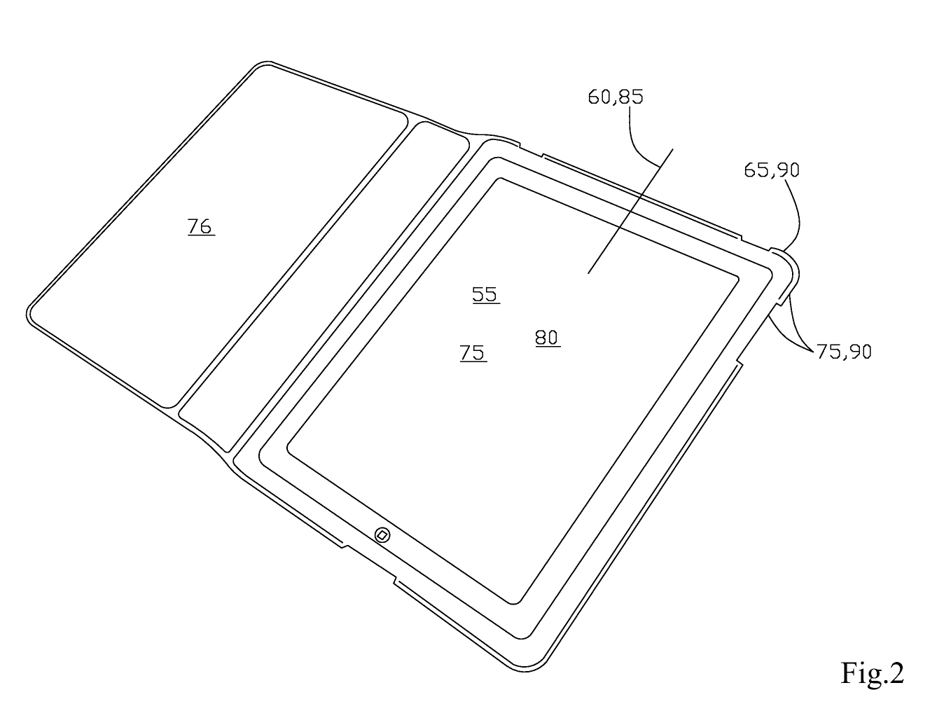

Broadly, with initial reference to FIG. 1 shown is a perspective view of the planar article 55 having the plane 60 and the outer periphery 65 are also shown, or more specifically the tablet computer 75, the planar display 80, the plane formed by the display 85, and the outer periphery 90 of the tablet computer 75. Next, FIG. 2 shows a perspective view of the planar article 55 having the plane 60 and the outer periphery 65 also shown, or more specifically the tablet computer 75, the planar display 80, the plane 85 formed by the display 80, and the outer periphery 90 of the tablet computer 75, wherein the tablet computer 75 also has the close fitting protective cover 76 that is opened to expose the display 80, the close fitting cover 76 also creates the double outer periphery 70 or 95 on either the planar article 55 of the tablet computer 75.

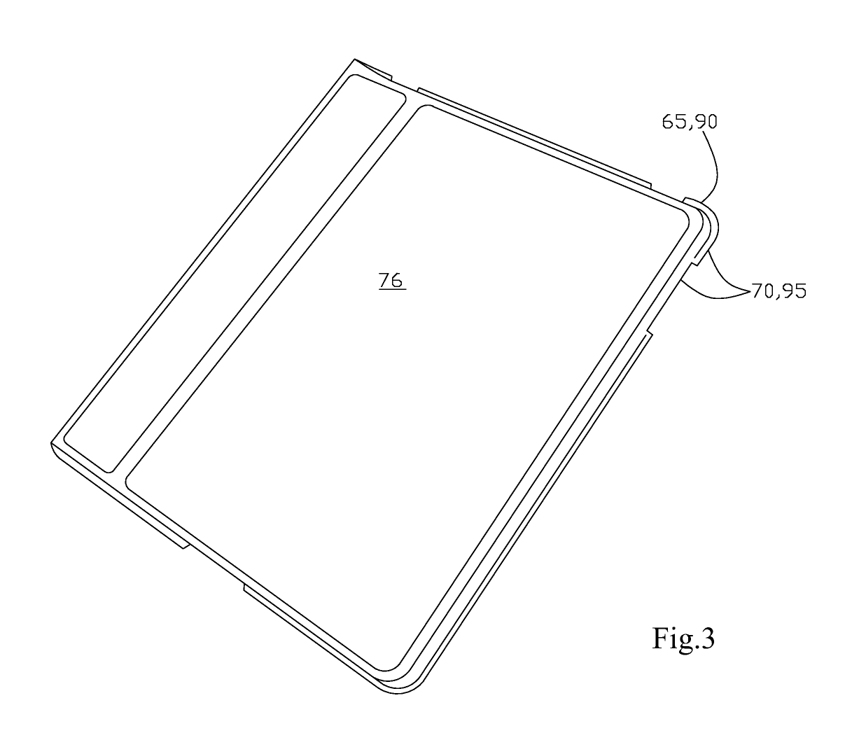

Continuing, FIG. 3 shows a perspective view of the planar article 55 having the plane 60 and the outer periphery 65 also shown, or more specifically the tablet computer 75, the planar display 80, the plane 85 formed by the display 80, and the outer periphery 90 of the tablet computer 75, wherein the tablet computer 75 also has the close fitting protective cover 76 that is closed to protect the display 80, the close fitting cover 76 also creates the double outer periphery 70 or 95 on either the planar article 55 or the tablet computer 75.

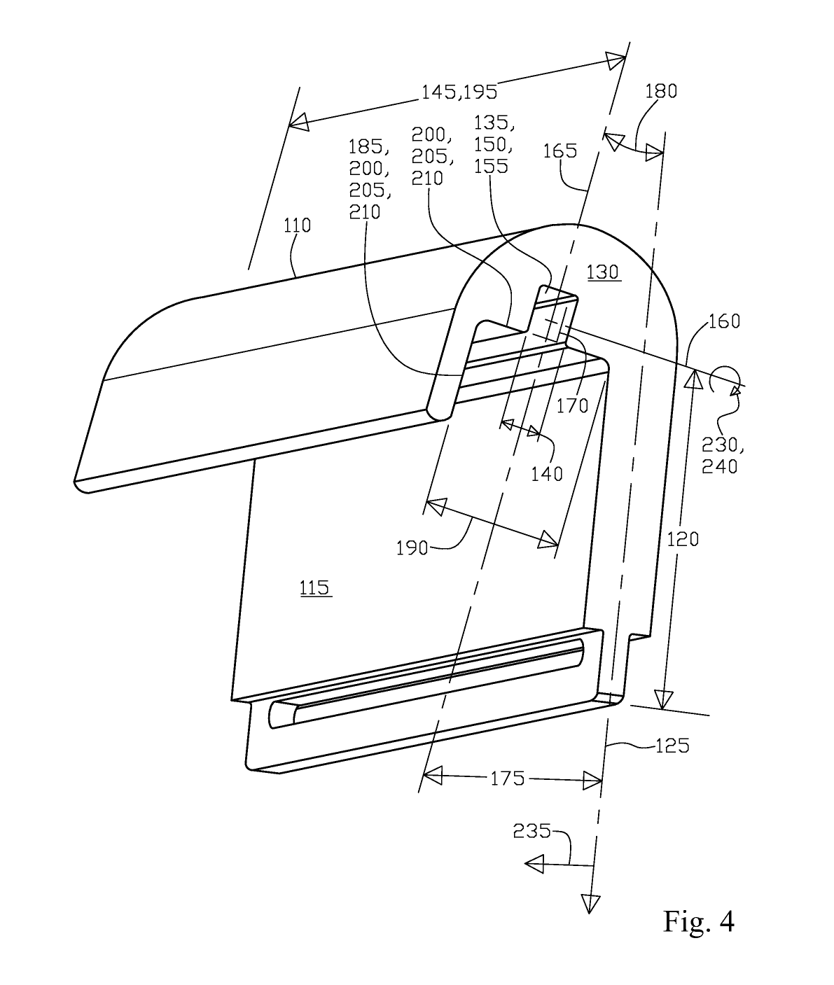

Further, FIG. 4 shows a perspective view of the clip 110 detail including the extension portion 115, the extension portion length 120, the extension axis 125, the channel portion 130, the offset primary channel 135, the width 140 and length 145 of the primary channel 135, the surface area 150 of the primary channel 135, the unit surface pressure loading 155 of the primary channel 135, the long axis 160 of the primary channel 135, and the short axis 165 of the primary channel 135. Also, FIG. 4 shows the perpendicular relationship 170 of the primary channel 135 long axis 160 to the extension axis 125, the substantially parallel relationship 175 of the extension axis 125 to the primary channel 135 short axis 165, the acute angle 180 between the extension axis 125 and the primary channel 135 short axis 165, the secondary channel 185, width 190 of the secondary channel 185, length 195 of the secondary channel 185, surface area 200 of the secondary channel 185, unit surface pressure loading 205 of the secondary channel 185, and frictional contact 210 of the secondary channel 185.

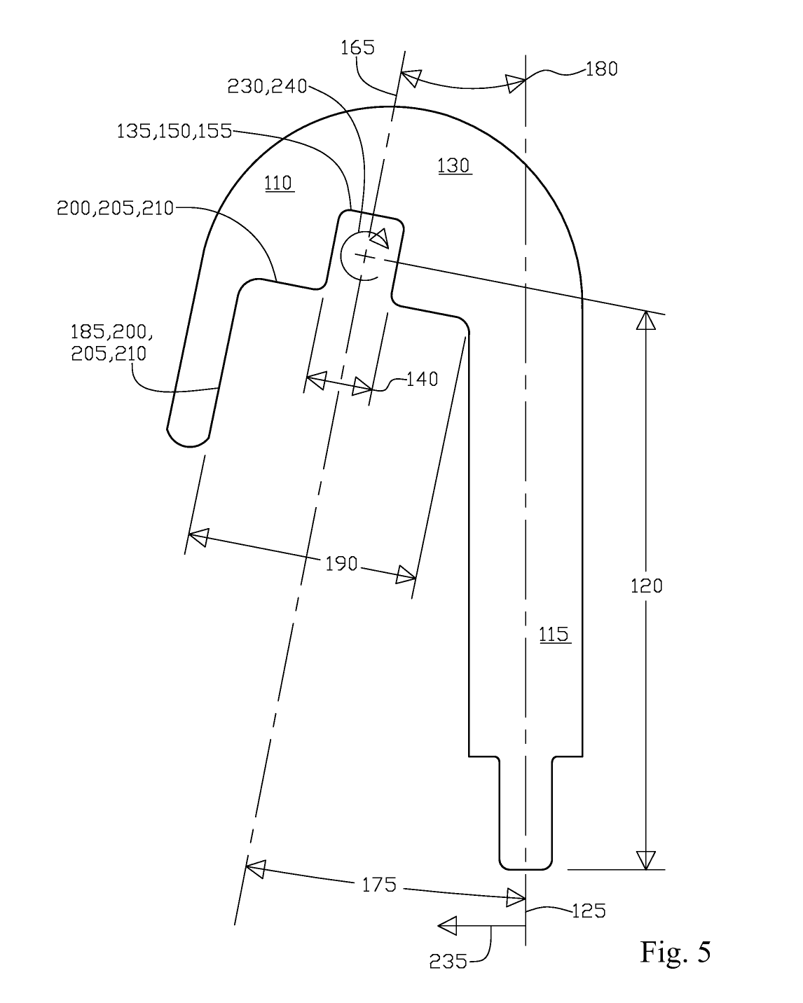

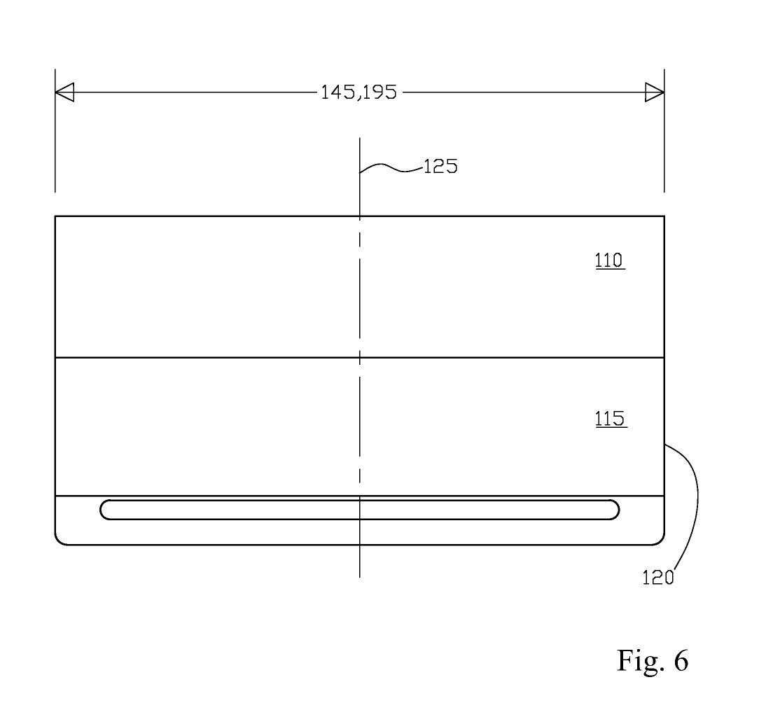

Next, FIG. 5 shows a side elevation view of the clip 110 including the extension portion 115, the extension portion 115 length 120, the extension axis 125, the channel portion 130, the offset primary channel 135, the width 140 of the primary channel 135, the surface area 150 of the primary channel 135, the unit surface pressure loading 155 of the primary channel 135, the short axis 165 of the primary channel 135, the substantially parallel relationship 175 of the extension axis 125 to the primary channel 135 short axis 165. Also, FIG. 5 shows the acute angle 180 between the extension axis 125 and the primary channel 135 short axis 165, the secondary channel 185, width 190 of the secondary channel 185, surface area 200 of the secondary channel 185, unit surface pressure loading 205 of the secondary channel 185, and frictional contact 210 of the secondary channel 185. Moving to FIG. 6 shows a plan elevation view of the clip 110 including the extension portion 115, the extension portion 115 axis 125, the length 120 of the extension portion 115, the length 145 of the primary channel 135, and the length 195 the secondary channel 185.

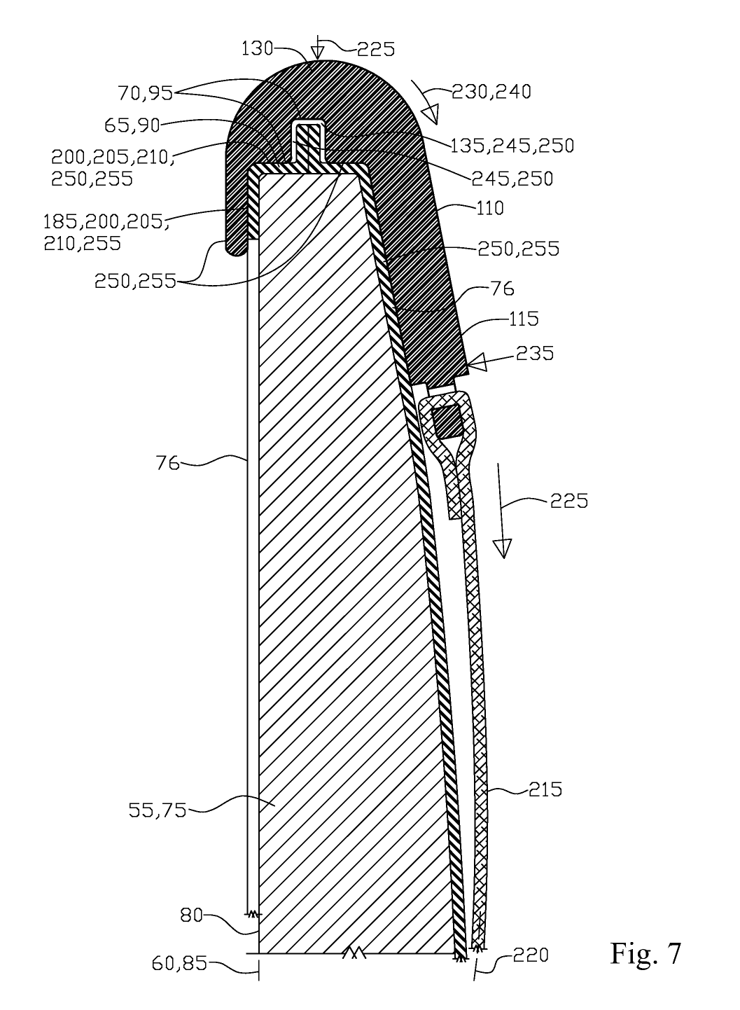

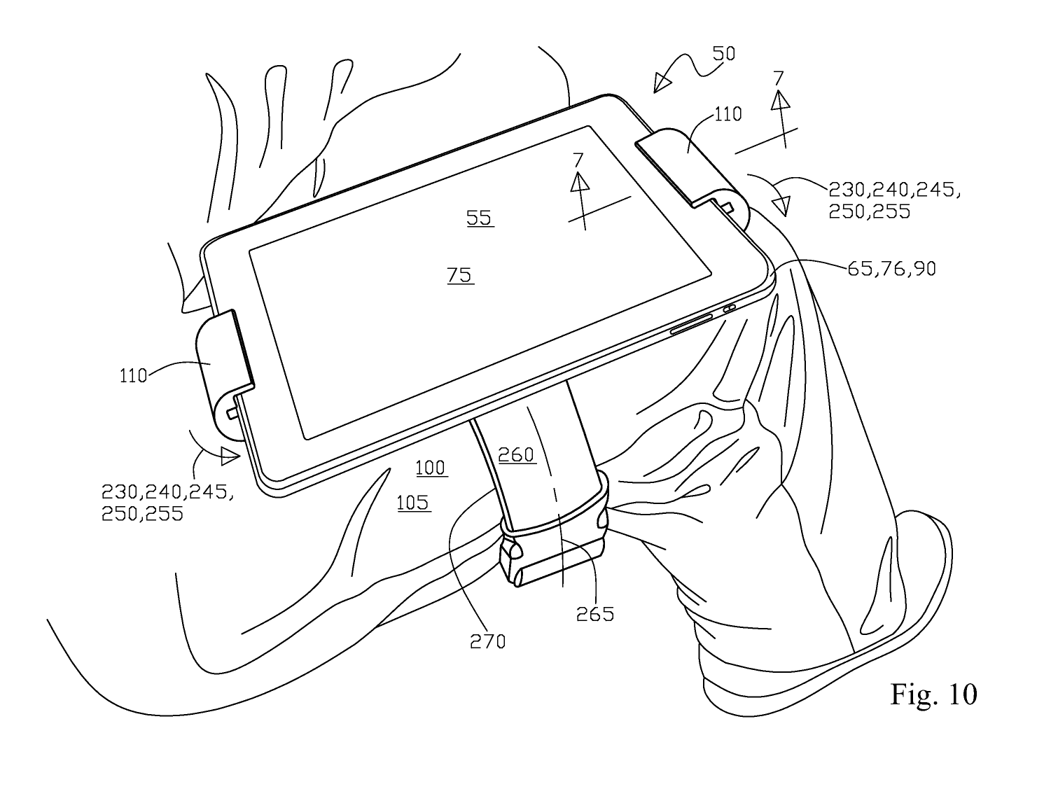

Moving toward FIG. 7 which is cross section 7-7 from FIG. 10, shows the interface of the clip 110 and extension member 215, with the double outer periphery 70 or 95 of both the planar article 55 and the tablet computer 75, being in particular with the close fitting protective cover 76 that is of a resilient nature further facilitating the moment 230 that creates the rotatable binding 250 of the primary channel 135 and the secondary channel 185 as against the double outer periphery 70 or 95 as shown from both the angle 180 that is between the extension axis 125 and the primary channel 135 short axis 165 and the compression 225 on the clip 110 from the extension member 215. This in turn creates the force 235 from the extension axis 125 to the primary channel 135 short axis 165. Further, this results in the unit surface pressure loading 155 of the primary channel 135 and the unit surface pressure loading 205 of the secondary channel 185 as against the resilient cover 76 at the double outer periphery 70 or 95 to increase the frictional contact 210 of the secondary channel 185 thus enabling the clip 110 to better grip the planar article 55 or tablet computer 75 outer periphery 70 or 95 respectively.

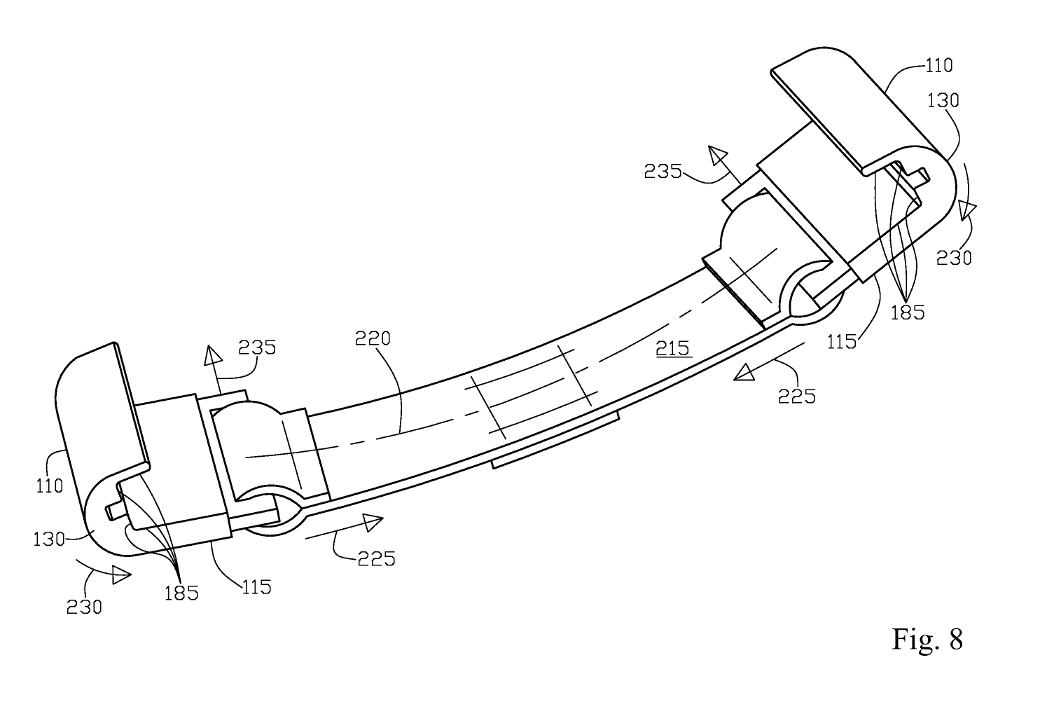

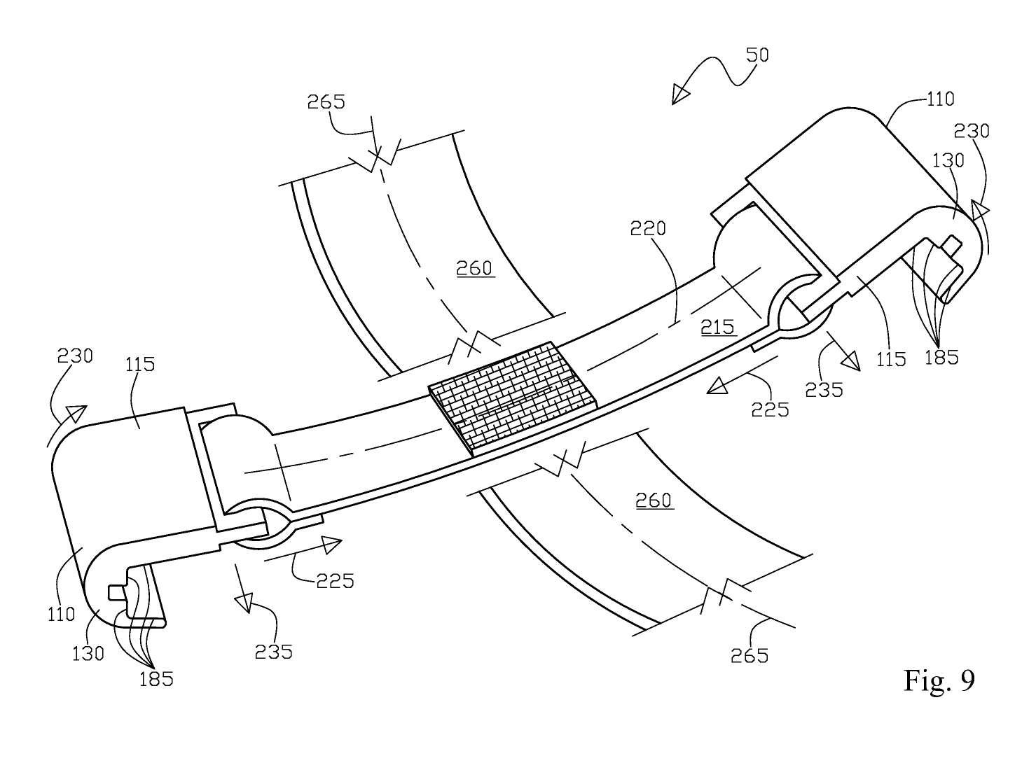

Continuing, FIG. 8 shows a perspective view of the pair of clips 110, with the channel portion 130, the secondary channel 185, with the extension member 215, the longitudinal axis 220 of the extension member 215, the compression 225 of the clips 110, and the force 235 on the clips 110 that result in the moment 230 on the clips 110. Further, FIG. 9 is the inverted view of the pair of clips 110 and extension member 215 of FIG. 8, showing the channel portion 130, the secondary channel 185, the longitudinal axis 220 of the extension member 215, the compression 225 of the clips 110, the force 235 on the clips 110 that result in the moment 230 on the clips 110, the band element 260, and the longwise axis 265 of the band element 260. Continuing, FIG. 10 shows a use perspective view of the retainer apparatus 50 that is adapted to attach to the user's leg 105 or a body portion 100, with the planar article 55 or tablet computer 75 shown retained to the user via the clips 110 having the moment 230 causing the rotatable binding 250 of the clip 110 upon the outer periphery 65 or 90 or double outer periphery 70 or 95 of the planar article 55 or tablet computer 75, thus allowing use of the tablet computer 75 without having to manually hold it in place by the user.

Broadly, in looking at FIGS. 4 through 10, the present invention of the retainer apparatus 50 is for removably engaging a planar article 55 having an outer periphery 65, the article planar portion forming a plane 60, wherein the retainer apparatus 50 is adapted to be removably engaged 270 to a body portion 100, see FIG. 10 for the end usage view. Looking in particular at FIGS. 4, 5, and 6, the retainer apparatus 50 includes a plurality of clips 110 each having an extension portion 115 and a channel portion 130, with each channel portion 130 being removably engagable to the article 55 outer periphery 65, see FIG. 7, each clip 110 extension portion 115 includes an extension axis 125, the clip 110 further has an offset primary channel 135 that is disposed within the channel portion 130. With the offset primary channel 135 including a primary channel 135 long axis 160 that is perpendicular 170 to the extension axis 125 and a primary channel 135 short axis 165 that is substantially parallel 175 to the extension axis 125, see FIGS. 4 and 5 specifically. Wherein the extension axis 125 and the primary channel 135 short axis 165 form an acute angle 180 to one another resulting in the extension axis 125 angling away from the article plane 60 when each clip 110 is engaged to the article outer periphery 65, see FIG. 7 in particular.

Looking toward FIGS. 7 through 10, further included in the retainer apparatus 50 is a detachable extension member 215 having a longitudinal axis 220 that is disposed to span between said clips 110 when the extension member 215 is attached to each extension portion 115 resulting in the clips 110 being compressed 225 as against the article 55 outer periphery 65 thereby also creating a moment 230 that is about the primary channel 135 long axis 160 from the acute angle 180 causing a force 235 from the extension axis 125 to the short axis 165. This moment 230 in effect rotating 240 the clip 110 to both compress and rotatably bind 240 the primary channel portion 135 as against the article 55 outer periphery 65 for the purpose of initiating frictional contact 245 on all primary channel 135 sides for an improved frictional contact as between the clip 110 and the article 55 outer periphery 65, see in particular FIG. 7.

Referring to FIGS. 9 and 10, the retainer apparatus 50 also includes a disconnectable band element 260 having a longwise axis 265, wherein the band element 260 is removably attached to the extension member 215 and further the band element 260 is adapted to removably engage 270 the body portion 100, wherein operationally the retainer apparatus 50 removably retains the article 55 to the body portion 100 while in use as best shown in FIG. 10.

As an optional further refinement of the clip 110 and in particular the channel portion 130 of the retainer apparatus 50, each clip 110 can further comprise a secondary channel 185 that is larger than and disposed parallel to and in communication with the primary channel 135 facing towards the extension portion 115, see FIGS. 4 and 5. Wherein the secondary channel 185 further adds frictional contact 255 to the article 55 outer periphery 65 from the moment 230 rotating 250 the clip 110 primary 135 and secondary channels 185 as against the article 55 outer periphery 65 when the article 55 has a double outer periphery 70, as best shown in FIG. 7. Also, the secondary channel 185 has a preferable width 190 that is at least two (2) times a width 140 of the primary channel 135, see FIGS. 4 and 5. Further, on the clip 110 the acute angle 180 is preferably in the range of ten (10) to thirty (30) degrees, as best shown in FIGS. 4 and 5.

Continuing on the clip 110, in referring to FIGS. 4 and 6, the clip 110 extension portion 115 has a length 120 equal to a length 145 of the primary channel 135 along the channel long axis 160, being operational to provide a surface area 150 and 200 respectively of the primary 135 and secondary 185 channels contacting the article 55 double outer periphery 70 for an optimal surface unit pressure loading placed upon the cover 76 from the compression 225 and moment 230 upon the clip 110 from the extension member 215, see FIG. 7.

In the preferred embodiment, the present invention for a retainer apparatus 50 is for removably engaging a tablet computer 75 having a planar display 80 and an outer periphery 90, the tablet computer display 80 forming a plane 85, see FIGS. 1 through 3, wherein the retainer apparatus 50 is adapted to be removably engaged to a user's leg 105, see FIG. 10 for the end use view. The retainer apparatus 50 includes a pair of opposed clips 110 each having an extension portion 115 and a channel portion 130, each channel portion 130 being removably engagable to the tablet 75 outer periphery 90, see FIG. 7. Each clip 110 extension portion 115 includes an extension axis 125, the clip 110 further has an offset primary channel 135 that is disposed within the channel portion 130, see FIGS. 4 and 5. The offset primary channel 135 including a primary channel 135 long axis 160 that is perpendicular 170 to the extension axis 125 and a primary channel 135 short axis 165 that is substantially parallel 175 to the extension axis 125, again see FIGS. 4 and 5. Wherein the extension axis 125 and the primary channel 135 short axis 165 form an acute angle 180 to one another resulting in the extension axis 125 angling away from the display plane 85 when each clip 110 is engaged to the tablet 75 outer periphery 90, see FIGS. 4, 5, and 7.

Further included in the preferred embodiment of the retainer apparatus 50 is a detachable extension member 215 having a longitudinal axis 220 that is disposed to span between the opposing pair of clips 110 when the extension member 215 is attached to each extension portion 115, see FIGS. 7, 8, and 9, resulting in the clips 110 being compressed 225 as against the tablet 75 outer periphery 90, see FIG. 7. This compression 225 also creating a moment 230 that is about the primary channel 135 long axis 160 from the acute angle 180 causing a force 235 from the extension axis 125 to the short axis 165 in effect rotating 240 the clip 110 to both compress and rotatably bind 240 the primary channel portion 135 as against the tablet 75 outer periphery 90 for the purpose of initiating frictional contact 245 on all primary channel 135 sides for an improved frictional contact as between the clip 110 and the tablet 75 outer periphery 90. Also included in the preferred embodiment of the retainer apparatus 50 is a disconnectable band element 260 having a longwise axis 265, wherein the band element 260 is removably attached to the extension member 215, see FIGS. 8 and 9, further the band element 260 is adapted 270 to extend around and removably engage the user's leg 105, wherein operationally the preferred embodiment of the retainer apparatus 50 removably retains the tablet computer 75 to the user's leg 105, as shown in FIG. 10.

On the preferred embodiment of the retainer apparatus 50, optionally each clip 110 can further comprise a secondary channel 185 that is larger than and disposed parallel to and in communication with the primary channel 135 facing towards the extension portion 115, see FIGS. 4 and 5. Wherein the secondary channel 185 further adds frictional contact 255 to the tablet computer 75 outer periphery 90 from the moment 230 rotating the clip 110 primary 135 and secondary 185 channels as against the tablet computer 75 outer periphery 90 when the tablet computer 75 has a double outer periphery 95, as best shown in FIG. 7. Further, optionally the secondary channel 185 can have a width 190 that is at least two (2) times a width 140 of the primary channel 135, as best shown in FIGS. 4 and 5. Additionally the clip 110 acute angle 180 is preferably in the range of ten (10) to thirty (30) degrees, as again shown in FIGS. 4 and 5.

Further, optionally on the preferred embodiment of the retainer apparatus 50, each clip 110 extension portion 115 can have a length 120 equal to a length 145 of the primary channel 135 along the channel 135 long axis 160, being operational to provide a surface area 150 and 200 respectively of the primary 135 and secondary 185 channels contacting the tablet computer 75 double outer periphery 95 for an optimal surface unit pressure loading upon the cover 76 from the compression 225 and moment 230 upon the clip 110 from the extension member 215.

On the use of the retainer apparatus 50 for the article 55 meaning tablet computer 75, it would preferably be an APPLE iPad used with applications relating to pilot navigation charts and other flying related applications, wherein the iPad would be mounted to the pilots leg 105 as what is commonly termed a “knee board” via use of the retainer apparatus 50 which gives the pilot an added navigation and flight information tool in the cockpit, wherein the pilot can use this added navigation and flight information tool in any aircraft they are using-thus making the tablet computer 75 and the retainer apparatus 50 completely portable in the pilot going from plane to plane. One other point is that the close fitting cover 76 for the tablet computer 75 that acts to protect the tablet computer 75 is assumed to be permanently used or attached to the tablet computer 75, wherein the retainer apparatus 50 is primarily designed to accommodate the cover 76 at all times, thus the double outer periphery 95 is a result of the cover 76 itself having an outer peripheral seam that primarily resides in the primary channel 135 and the remainder of the cover 76 outer periphery residing in the secondary channel 185, wherein if no cover 76 were used with the tablet computer 75, then the tablet computer would have a single outer periphery 90 that would reside in the secondary channel 185 only. Further, even though the retainer apparatus 50 is shown engaged to the user's leg 105, it could also be adapted to engage any other body portion such as an arm or a waist and the like.

The clip 110 is preferably constructed from a molded or milled plastic, or could be made of metal, or any other material that is fairly rigid. Further on the clip 110, the extension portion length 120, primary channel 135 length 145, and secondary channel 185 length 195 are all three preferably about 1.36 inches, wherein a width 140 of the primary channel 135 is preferably about 0.15 inches with the primary channel 135 cross section being square resulting in the primary channel 135 depth being the same at about 0.15 inches, thus resulting in a surface area 150 of the primary channel 135 of about 0.15 times 1.36 times 3 (surfaces) equals about 0.612 square inches. Further, with the compression 225 force from the extension member 215 being preferably at least one pound force resulting in a unit surface pressure loading 155 of at least one pound divided by 0.612 square inches equaling at least 1.63 pounds per square inch (psi) as placed against the outer periphery 90. Further on the clip 110, the width 190 of the secondary channel 185 is preferably about 0.42 inches and the depth of the secondary channel (exclusive of the primary channel 135) is about 0.32 inches, that results in a surface area 200 of the secondary channel 185 of 0.32 inches times 1.36 inches times 3 (secondary channel 185 sides) minus 0.150 inches times 1.36 inches (the primary channel 135 gap) equals about 1.1 square inches resulting in a unit surface pressure loading 205 equaling one pound divided by 0.612 square inches (area 150 of the primary channel 135) plus 1.1 square inches (area 200 of the secondary channel 185) equals 0.58 pounds per square inch (psi) as against the cover 76 forming the double outer periphery 95. Thus, these two unit surface pressure loadings 155 and 205 respectively adequately have frictional contact with the tablet computer 75 or in the preferably case of the resilient cover 76 permanently on the tablet computer 75 without damaging the computer 75 or cover 76.

The extension member 215 is preferably constructed of a woven nylon strap or equivalent, the extension member 215 can be elastic, or have a length adjustment along the longitudinal axis 220, or have a fixed length along the longitudinal axis 220 all sized to create the desired compression 225, further the extension member 215 can be detachable from the clips 110. The resultant moment 230 from the compression 225 is the Sine of angle 180 (assumed at 20 degrees) being equal to 0.34 times the length 120 of the extension portion which is 1.36 inches thus equaling 0.47 inches (which is the increased moment arm effect of angle 180, this would be added to width 190 divided by two, this results in 0.42 inches divided by two equaling 0.21 inches plus 0.47 inches equaling 0.68 inches being the effective moment arm as between the attachment of the extension member 215 to the extension portion 115 and the center of the primary channel 135. Thus moment 230 equals 0.68 inches times the compression 225 of one pound equals 0.68 inch-pounds for moment 230. Further the force 235 equals moment 230 of 0.68 inch-pounds divided by length 120 of 1.36 inches, so 0.68 inch-pounds divided by 1.36 inches equals 0.5 pounds for force 235.

The band element 260 is preferably constructed of a woven nylon strap or equivalent, the band element 260 can be elastic, or have a length adjustment along the longwise axis 265, or have a fixed length along the longwise axis 265 all sized to create the desired snugness on the user's leg 105, further the band element 260 can be detachable from itself.

### CONCLUSION

Accordingly, the present invention of the retainer apparatus 50 assembly has been described with some degree of particularity directed to the embodiments of the present invention. It should be appreciated, though; that the present invention is defined by the following claims construed in light of the prior art so modifications of the changes may be made to the exemplary embodiments of the present invention without departing from the inventive concepts contained therein.

1. A retainer apparatus for removably engaging to a planar article having an outer periphery, the article planar portion forming a plane, wherein said retainer apparatus is adapted to be removably engaged to a body portion, comprising:
(a) a plurality of clips each having an extension portion and a channel portion, each said channel portion being removably engagable to the article outer periphery, each said clip extension portion includes an extension axis, said clip further has an offset primary channel that is disposed within said channel portion, with said offset primary channel including a primary channel long axis that is perpendicular to said extension axis and a primary channel short axis that is substantially parallel to said extension axis, wherein said extension axis and said primary channel short axis form an acute angle to one another resulting in said extension axis angling away from the article plane when each said clip is engaged to the article outer periphery;
(b) a detachable extension member having a longitudinal axis that is disposed to span between said clips when said extension member is attached to each said extension portion resulting in said clips being compressed as against the article outer periphery thereby also creating a moment that is about said primary channel long axis from said acute angle causing a force from said extension axis to said short axis in effect rotating said clip to both compress and rotatably bind said primary channel portion as against the article outer periphery for the purpose of initiating frictional contact on all primary channel sides for an improved frictional contact as between said clip and the article outer periphery; and
(c) a disconnectable band element having a longwise axis, wherein said band element is removably attached to said extension member and further said band element is adapted to removably engage the body portion, wherein operationally said retainer apparatus removably retains the article to the body portion.

2. A retainer apparatus according to claim 1 wherein each said clip further comprises a secondary channel that is larger than and disposed parallel to and in communication with said primary channel facing towards said extension portion, wherein said secondary channel further adds frictional contact to the article outer periphery from said moment rotating said clip primary and secondary channels as against the article outer periphery when the article has a double outer periphery.

3. A retainer apparatus according to claim 2 wherein said secondary channel has a width that is at least two (2) times a width of said primary channel.

4. A retainer apparatus according to claim 1 wherein each said clip acute angle in is the range of ten (10) to thirty (30) degrees.

5. A retainer apparatus according to claim 2 wherein each said clip extension portion has a length equal to a length of said primary channel along said channel long axis, being operational to provide a surface area of said primary and secondary channels contacting the article double outer periphery for an optimal surface unit pressure loading from said compression and moment upon said clip from said extension member.

6. A retainer apparatus for removably engaging to a tablet computer having a planar display and an outer periphery, the tablet display forming a plane, wherein said retainer apparatus is adapted to be removably engaged to a user's leg, comprising:
(a) a pair of opposed clips each having an extension portion and a channel portion, each said channel portion being removably engagable to the tablet outer periphery, each said clip extension portion includes an extension axis, said clip further has an offset primary channel that is disposed within said channel portion, with said offset primary channel including a primary channel long axis that is perpendicular to said extension axis and a primary channel short axis that is substantially parallel to said extension axis, wherein said extension axis and said primary channel short axis form an acute angle to one another resulting in said extension axis angling away from the display plane when each said clip is engaged to the tablet outer periphery;
(b) a detachable extension member having a longitudinal axis that is disposed to span between said opposing pair of clips when said extension member is attached to each said extension portion resulting in said clips being compressed as against the tablet outer periphery thereby also creating a moment that is about said primary channel long axis from said acute angle causing a force from said extension axis to said short axis in effect rotating said clip to both compress and rotatably bind said primary channel portion as against the tablet outer periphery for the purpose of initiating frictional contact on all primary channel sides for an improved frictional contact as between said clip and the tablet outer periphery; and
(c) a disconnectable band element having a longwise axis, wherein said band element is removably attached to said extension member and further said band element is adapted to extend around and removably engage the user's leg, wherein operationally said retainer apparatus removably retains the tablet computer to the user's leg.

7. A retainer apparatus according to claim 6 wherein each said clip further comprises a secondary channel that is larger than and disposed parallel to and in communication with said primary channel facing towards said extension portion, wherein said secondary channel further adds frictional contact to the tablet computer outer periphery from said moment rotating said clip primary and secondary channels as against the tablet computer outer periphery when the tablet computer has a double outer periphery.

8. A retainer apparatus according to claim 7 wherein said secondary channel has a width that is at least two (2) times a width of said primary channel.

9. A retainer apparatus according to claim 6 wherein each said clip acute angle in is the range of ten (10) to thirty (30) degrees.

10. A retainer apparatus according to claim 7 wherein each said clip extension portion has a length equal to a length of said primary channel along said channel long axis, being operational to provide a surface area of said primary and secondary channels contacting the tablet computer double outer periphery for an optimal surface unit pressure loading from said compression and moment upon said clip from said extension member.
